(19) United States
(12) Patent Application Publication
(10) Pub. No.: US 2024/0036850 A1
(43) Pub. Date: Feb. 1, 2024

(54) CONFIGURATION AWARE FIRMWARE UPDATE

(71) Applicant: Dell Products L.P., Round Rock, TX (US)

(72) Inventors: Balakrishna PADHY, Bangalore (IN); Chandrasekhar REVURI, Bangalore (IN); Penchal Reddy T Y, Mydukuru (IN); Raveendra Babu MADALA, Bangalore (IN); Rama Rao BISA, Bangalore (IN); Shankar MARIMUTHU, Hosur (IN)

(73) Assignee: Dell Products L.P., Round Rock, TX (US)

(21) Appl. No.: 17/876,128

(22) Filed: Jul. 28, 2022

(51) Int. Cl. G06F 8/65

(52) U.S. Cl. CPC G06F 8/65

(57) ABSTRACT

An information handling system may include at least one processor and a memory. The information handling system may be configured to: receive an update package for applying an update to at least one information handling resource of the information handling system, wherein the update package includes metadata regarding at least one dependency of the update package; subsequent to receiving the update package, retrieve a revised version of the metadata, wherein the revised version of the metadata indicates a revised at least one dependency; based on the revised at least one dependency, carry out a configuration change; and apply the update.

### TECHNICAL FIELD

The present disclosure relates in general to information handling systems, and more particularly to improving the reliability of updates such as firmware updates by providing such updates in a configuration-dependent manner.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To correct bugs and/or enhance functionality, updates (e.g., firmware updates) may be provided for an information handling system from time to time. The specific example of firmware updates is described in detail herein for the sake of concreteness. However, one of ordinary skill in the art with the benefit of this disclosure will appreciate its applicability to other types of updates.

Embodiments of this disclosure may use firmware updates that are packaged according to a standardized update package payload. For example, Dell® may provide such updates in a Dell Update Package (DUP) format. Other systems may use other formats, as one of ordinary skill in the art with the benefit of this disclosure will appreciate. In general, any of such package formats may be referred to herein as an “update package” or a “firmware update package.”

Along with the updates themselves, a firmware update package may also encapsulate metadata such as applicability, dependencies, etc. The presence of certain components (e.g., hardware, software, and/or firmware components) in an information handling system while applying a given update might make the system unusable or cause the update to fail, and so the metadata can also be used to indicate such compatibility constraints.

In general, the metadata in an update package typically contains only the information that was available at the time the update package was created. Accordingly, information about the configuration details required for applying updates might be out of date or missing altogether.

Embodiments of this disclosure improve on this situation, for example by obtaining the latest information while the updates are being considered and applied. In particular, embodiments provide a way of validating the configuration dependencies and/or performing configuration changes that may be required in order to apply an update successfully.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with firmware updates may be reduced or eliminated.

In accordance with embodiments of the present disclosure, an information handling system may include at least one processor and a memory. The information handling system may be configured to: receive an update package for applying an update to at least one information handling resource of the information handling system, wherein the update package includes metadata regarding at least one dependency of the update package; subsequent to receiving the update package, retrieve a revised version of the metadata, wherein the revised version of the metadata indicates a revised at least one dependency; based on the revised at least one dependency, carry out a configuration change; and apply the update.

In accordance with these and other embodiments of the present disclosure, a method may include an information handling system receiving an update package for applying an update to at least one information handling resource of the information handling system, wherein the update package includes metadata regarding at least one dependency of the update package; subsequent to receiving the update package, the information handling system retrieving a revised version of the metadata, wherein the revised version of the metadata indicates a revised at least one dependency; based on the revised at least one dependency, the information handling system carrying out a configuration change; and the information handling system applying the update.

In accordance with these and other embodiments of the present disclosure, an article of manufacture may include a non-transitory, computer-readable medium having computer-executable code thereon that is executable by a processor of an information handling system for: receiving an update package for applying an update to at least one information handling resource of the information handling system, wherein the update package includes metadata regarding at least one dependency of the update package; subsequent to receiving the update package, retrieving a revised version of the metadata, wherein the revised version of the metadata indicates a revised at least one dependency; based on the revised at least one dependency, carrying out a configuration change; and applying the update.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example method, in accordance with embodiments of the present disclosure; and

FIG. 3 illustrates an example method, in accordance with embodiments of the present disclosure.

### DETAILED DESCRIPTION

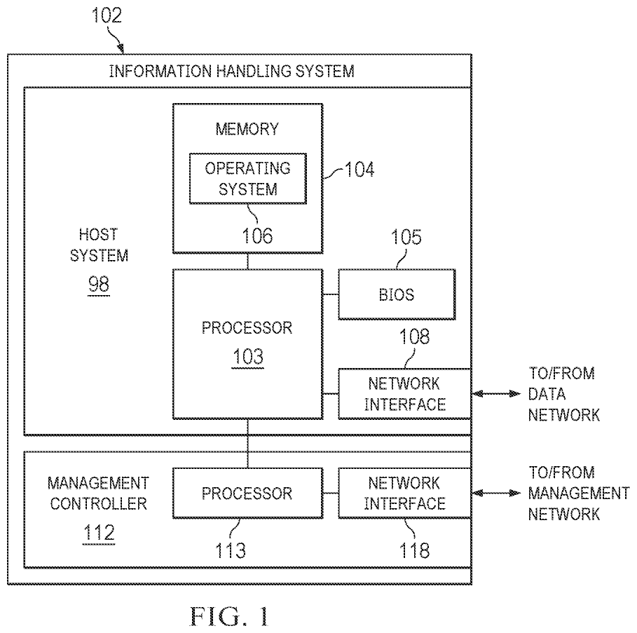

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives, solid-state drives, and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network.

Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide firmware updates in a configuration-aware manner, customizing the updates that are installed based on the existing hardware and/or software and/or firmware configuration of information handling system 102. Some embodiments also provide for making changes to that configuration (e.g., disabling and/or modifying a component) prior to installing an update in order to increase the chances of success.

Some embodiments may use an “update path catalog,” which generally refers to a data structure that includes information about pre-validated system configurations that are known to be compatible with a given firmware update. The update path catalog is typically published online and accessible by a management controller via the internet, but in other situations (e.g., if no internet access is available to the management controller), a local version may be generated and modified in-situ. As discussed below, the update path catalog may be revised from time to time as additional information regarding an update becomes available.

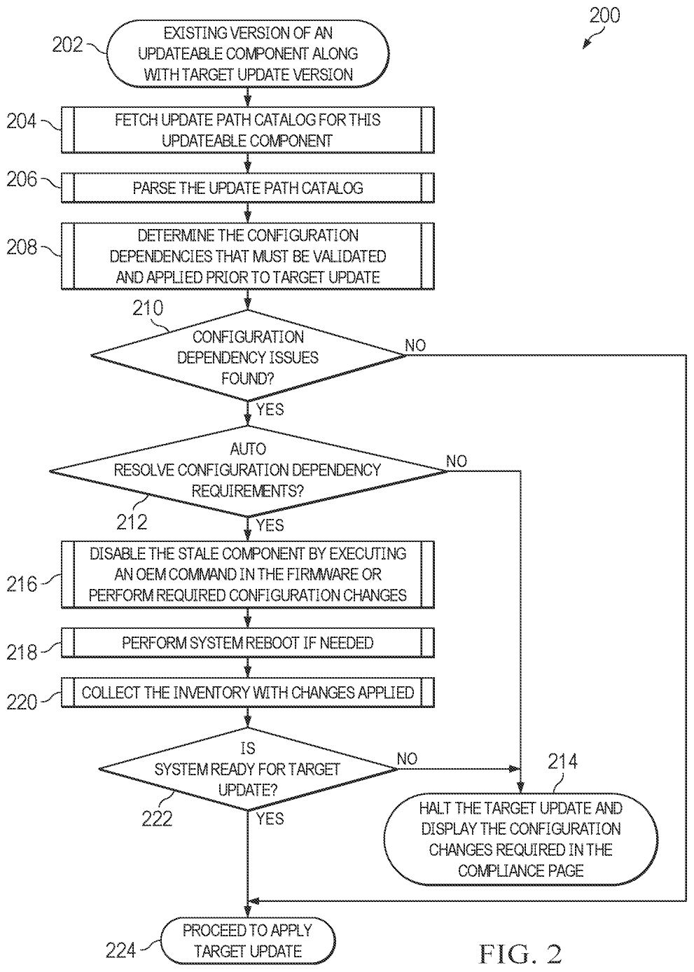

Turning now to FIG. 2, an example method 200 is shown, according to some embodiments. Method 200 details a technique for using a configuration validator for resolving configuration dependency issues as may be required while applying a specific update. The configuration validator may be integrated into an update interface (e.g., a command line interface or a graphical interface). In particular, method 200 depicts the high-level steps that may be performed by the configuration validator in assessing the hardware dependencies that might be required for applying a target update. Further, the validator may disable a component if necessary based on information in the update path catalog.

At step 202, the validator may determine that a given updateable component is in need of an update. For example, it may determine an existing version of the firmware installed on the component, as well as a target update version. At step 204, the validator may fetch the update path catalog for this component. Once the update path catalog is procured, it may be parsed at step 206.

Based on the parsed update path catalog, the validator may determine at step 208 any configuration dependency changes that might be required before attempting the target update. If no such dependency issues are found at step 210, then the method may proceed to step 224 and apply the update.

In one embodiment, a preference setting may be available regarding whether or not configuration dependency requirements should be automatically resolved. The default value for this preference may be set to true, in which case the validator may perform dependency validation and apply the required configuration changes.

If one or more configuration dependency issues are found, at step 212, the method may check the preference setting regarding auto-resolving configuration dependency requirements. If the preference is disabled, then the method may halt the update and display a message regarding the required configuration changes in the console of the management controller as shown at step 214.

If update requirements are to be auto-resolved, then the configuration dependency details may be determined, and one or more scripts may be generated for applying the configuration changes. For example, such scripts may be used to change settings, disable hardware components (e.g., via OEM commands directed to such components), re-enable hardware components following the update, etc. At step 216, the changes may be carried out, with any necessary reboots taking place at step 218. For example, in the implementation shown, step 216 includes disabling a component. In other situations, step 216 may include implementing any other configuration change that may be needed.

If the configuration changes fail in some way, then at step 222, the method may determine that the system is not ready for update, and the update may be halted at step 214. If the configuration changes complete correctly, the update may be applied at step 224.

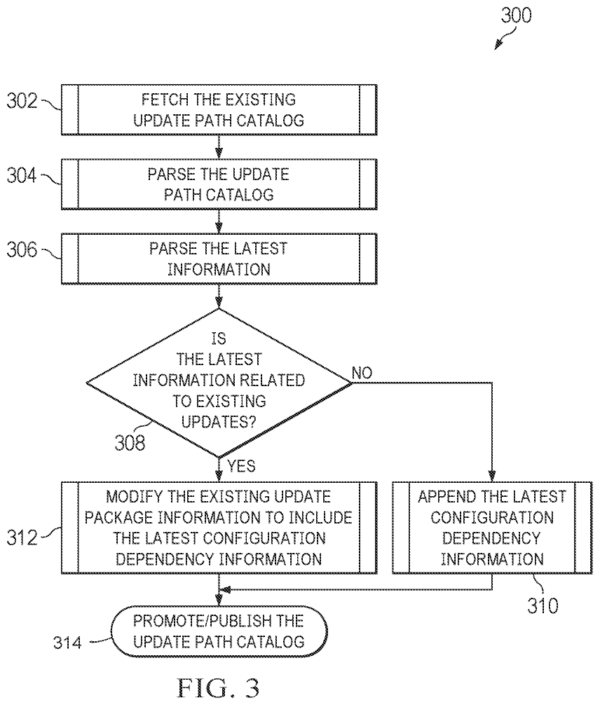

Turning now to FIG. 3, an example method 300 is shown for keeping the update path catalog up to date, according to one embodiment. In some embodiments, any given update package may include a reference (e.g., a uniform resource locator (URL) or the like) to its update path catalog. The published catalog may be revised whenever a new hardware dependency is introduced or discovered in the field (e.g., including unique identifiers such as a device ID and/or a vendor ID associated with the dependency).

At step 302, the existing update path catalog may be fetched (e.g., from its published location). At step 304, it may be parsed (e.g., to generate a live data structure from the text/binary file of the existing update path catalog). At step 306, the latest update information regarding update dependencies may also be parsed.

If the latest information relates to existing updates, then the existing update package may be modified to reflect the latest dependency information at step 312. If not, then the latest dependency information may be appended to the previous dependency information at step 310. The new version of the update path catalog may then be published at step 314.

One of ordinary skill in the art with the benefit of this disclosure will understand that the preferred initialization point for the methods depicted in FIGS. 2-3 and the order of the steps comprising those methods may depend on the implementation chosen. In these and other embodiments, these methods may be implemented as hardware, firmware, software, applications, functions, libraries, or other instructions. Further, although FIGS. 2-3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

Thus embodiments of this disclosure may provide many advantages. For example, embodiments may prevent a system from entering an unstable state by enforcing configuration changes requirements. This may be accomplished via the ability to dynamically supply configuration dependency information and configuration requirements after an update package is created. Embodiments may also provide a system for enforcing the configuration requirements while applying updates via any interface. Embodiments may provide a method for automatically applying any required configuration dependencies (e.g., by making configuration changes, applying other updates before the target update, disabling incompatible components, etc. at runtime).

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive an update package for applying an update to at least one information handling resource of the information handling system, wherein the update package includes metadata regarding at least one dependency of the update package;
subsequent to receiving the update package, retrieve a revised version of the metadata, wherein the revised version of the metadata indicates a revised at least one dependency;
based on the revised at least one dependency, carry out a configuration change; and
apply the update.

2. The information handling system of claim 1, wherein the update is a firmware update.

3. The information handling system of claim 1, wherein the information handling system implements a preference setting indicating whether configuration dependencies are to be automatically resolved, and wherein the configuration change is carried out in response to the preference setting being true.

4. The information handling system of claim 1, wherein the configuration change is carried out by a management controller of the information handling system.

5. The information handling system of claim 1, wherein the revised at least one dependency indicates an incompatible information handling resource that is incompatible with the update.

6. The information handling system of claim 5, further configured to:
disable the incompatible information handling resource prior to applying the update; and
re-enable the incompatible information handling resource after applying the update.

7. A method comprising:
an information handling system receiving an update package for applying an update to at least one information handling resource of the information handling system, wherein the update package includes metadata regarding at least one dependency of the update package;
subsequent to receiving the update package, the information handling system retrieving a revised version of the metadata, wherein the revised version of the metadata indicates a revised at least one dependency;
based on the revised at least one dependency, the information handling system carrying out a configuration change; and
the information handling system applying the update.

8. The method of claim 7, wherein the update is a firmware update.

9. The method of claim 7, wherein the information handling system implements a preference setting indicating whether configuration dependencies are to be automatically resolved, and wherein the configuration change is carried out in response to the preference setting being true.

10. The method of claim 7, wherein the configuration change is carried out by a management controller of the information handling system.

11. The method of claim 7, wherein the revised at least one dependency indicates an incompatible information handling resource that is incompatible with the update.

12. The method of claim 11, further comprising:
disabling the incompatible information handling resource prior to applying the update; and
re-enabling the incompatible information handling resource after applying the update.

13. An article of manufacture comprising a non-transitory, computer-readable medium having computer-executable code thereon that is executable by a processor of an information handling system for:
receiving an update package for applying an update to at least one information handling resource of the information handling system, wherein the update package includes metadata regarding at least one dependency of the update package;
subsequent to receiving the update package, retrieving a revised version of the metadata, wherein the revised version of the metadata indicates a revised at least one dependency;
based on the revised at least one dependency, carrying out a configuration change; and
applying the update.

14. The article of claim 13, wherein the update is a firmware update.

15. The article of claim 13, wherein the information handling system implements a preference setting indicating whether configuration dependencies are to be automatically resolved, and wherein the configuration change is carried out in response to the preference setting being true.

16. The article of claim 13, wherein the configuration change is carried out by a management controller of the information handling system.

17. The article of claim 13, wherein the revised at least one dependency indicates an incompatible information handling resource that is incompatible with the update.

18. The article of claim 17, wherein the code is further executable for:
disabling the incompatible information handling resource prior to applying the update; and
re-enabling the incompatible information handling resource after applying the update.
